(19) United States
(12) Patent Application Publication
(10) Pub. No.: US 2015/0006274 A1
(43) Pub. Date: Jan. 1, 2015

(54) Lifestyle Rewards System and Method

(71) Applicant: EveryMove, Inc., Seattle, WA (US)

(72) Inventors: Marcelo Aizenstein Furman Calbucci, Redmond, WA (US); Matthew Robert Carter, Seattle, WA (US)

(21) Appl. No.: 14/320,067

(22) Filed: Jun. 30, 2014

Related U.S. Application Data
(60) Provisional application No. 61/841,116, filed on Jun. 28, 2013.

(51) Int. Cl. G06Q 30/02

(52) U.S. Cl. CPC G06Q 30/0226
USPC 705/14.27

(57) ABSTRACT

Activity information is received from users, from devices and information services paired with the users, and from third parties and points are awarded to the users for the activities. Points may be converted into rewards.

### CROSS-REFERENCE TO RELATED APPLICATIONS

This application claims the benefit of U.S. Provisional patent application Ser. No. 61/841,116, filed Jun. 28, 2013, which application is incorporated herein for all purposes by this reference.

### FIELD

This disclosure relates to a method and system for rewarding healthy lifestyle activities.

### BACKGROUND

The following description includes information that may be useful in understanding the present invention. It is not an admission that any of the information provided herein is prior art or relevant to the presently claimed invention, or that any publication specifically or implicitly referenced is prior art.

Reward systems exist to reward behavior such as being a returning customer on an airline.

The Metabolic Equivalent of Task (“MET”) has been used to measure the metabolic energy cost of various activities. 1 MET is generally equal to the energy produced per unit surface area of an average person, seated, at rest. MET values for various activities generally range between 0.9, for someone sleeping, to 23, for someone running at a 4:17/mile pace.

Individuals may engage in healthy lifestyle activities, such as walking, running, going to the gym, and the like. These activities accrue various benefits to the individual and to the larger community, including lower health costs for the individual, the individual's insurance provider, and the individual's employer. The individual may enjoy certain of the benefits of the healthy lifestyle activities, but the individual does not share in the financial benefits which these activities accrue to the larger community; in fact, the individual will incur financial costs—such as gym membership, sporting equipment, and the like—and will spend time engaging in the healthy lifestyle activities. While healthy lifestyle activities are often enjoyable and a goal in-and-of-themselves, more such activities would be undertaken if individuals obtained consideration for the benefits which accrue to the larger community.

### BRIEF DESCRIPTION OF THE DRAWINGS

FIG. 1 is a network and device diagram illustrating exemplary computing devices configured according to embodiments disclosed in this paper.

FIG. 2 is a functional block diagram of an exemplary EveryMove Server computing device and some data structures and/or components thereof.

FIG. 3 is a functional block diagram of the EveryMove Datastore illustrated in the computing device of FIG. 2.

FIGS. 4A and 4B are a flowchart illustrating an example of a Manage User and Determine Points Routine.

FIG. 5 is a flowchart illustrating an example of a Manager User Routine.

FIGS. 6A and 6B are a flowchart illustrating an example of a Determine Points Routine.

FIG. 7 is a flowchart illustrating an example of an Activity Point Routine.

FIG. 8 is a flowchart illustrating an example of a Step Point Routine.

FIG. 9 is a flowchart illustrating an example of an Event Point Routine.

FIG. 10 is a flowchart illustrating an example of a Place Point Routine.

FIG. 11 is a flowchart illustrating an example of a Merge Activities Routine.

FIG. 12 is a flowchart illustrating an example of a Manage Verifier and Sponsor Routine.

### DETAILED DESCRIPTION

The following Detailed Description provides specific details for an understanding of various examples of the technology. One skilled in the art will understand that the technology may be practiced without many of these details. In some instances, structures and functions have not been shown or described in detail or at all to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connection between the elements can be physical, logical, or a combination thereof. Additionally, the words, “herein,” “above,” “below,” and words of similar import, when used in this application, shall refer to this application as a whole and not to particular portions of this application. When the context permits, words using the singular may also include the plural while words using the plural may also include the singular. The word “or,” in reference to a list of two or more items, covers all of the following interpretations of the word: any of the items in the list, all of the items in the list, and any combination of one or more of the items in the list. In the following discussion, capitalized terms are defined herein.

In overview, the disclosed method and system awards points for exercise and other healthy lifestyle activities. The disclosed method and system receives activity information from end users, from devices and information services paired with the end users, and from others and awards points for the activities. The disclosed method and system recognizes some or all of the following: that the intensity of an exercise is more important than the quantity of an exercise; that there are diminishing or even negative returns after certain thresholds of intensity, duration, and frequency; that there is exponential gain from exercising two, three, or four times per week, and almost no difference for five or more times; that motivating and being motivated by others (directly and through participation in group events) is a significant benefit for both the individual and the community; that activities which require deviation from routine have a higher correlation with a healthy lifestyle (doing yoga vs. mowing the lawn); that the effort expended by the individual should be strongly correlated with earned points; that a significant number of activities include “idle” or waiting time, such as bowling, playing baseball, and rock climbing; that different people have different perceptions of when an activity starts; and that a sigmoidal curve best describes the benefits of a fitness activity, where the health benefit in represented on the Y axis and the data points measuring the activity (intensity, frequency, duration, and the like) are represented on the X axis.

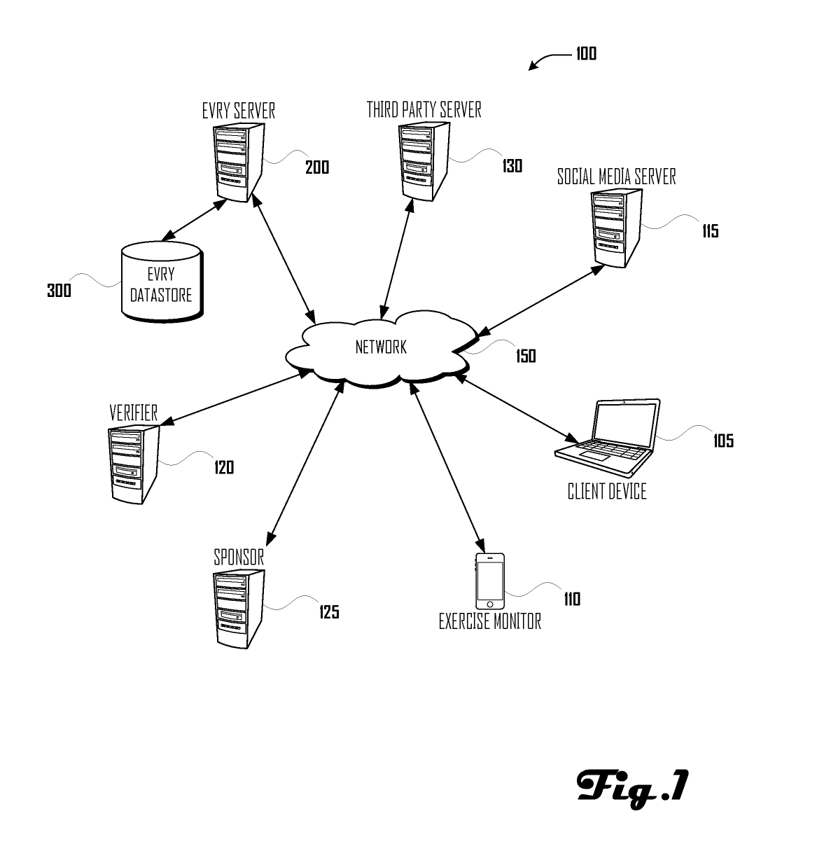

FIG. 1 is a network and device diagram illustrating exemplary computing devices configured according to embodiments disclosed in this paper. Illustrated in FIG. 1 are EveryMove Server 200, EveryMove Datasore 300, Client Device 105 used by a user, Exercise Monitor 110, Verifier 120, Social Media Server 115, Sponsor Server 125 used by a Reward Sponsor, and Third Party Server 130. In the discussion herein, capitalized terms are defined.

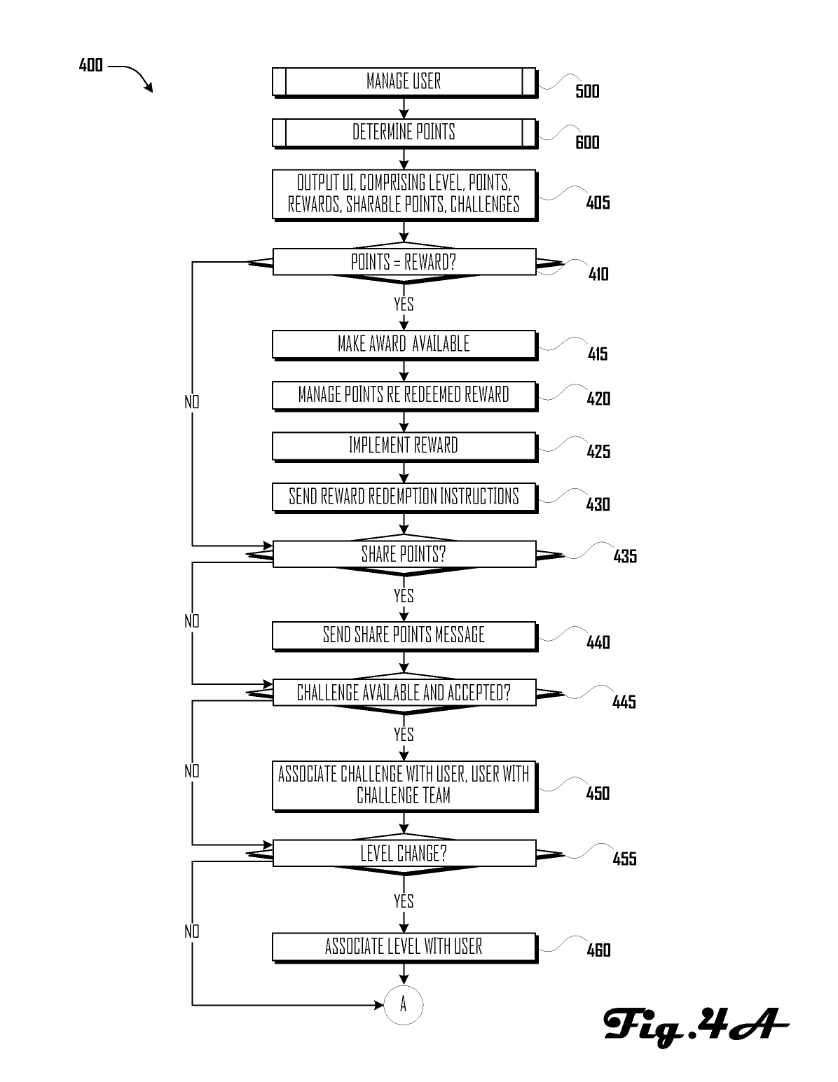

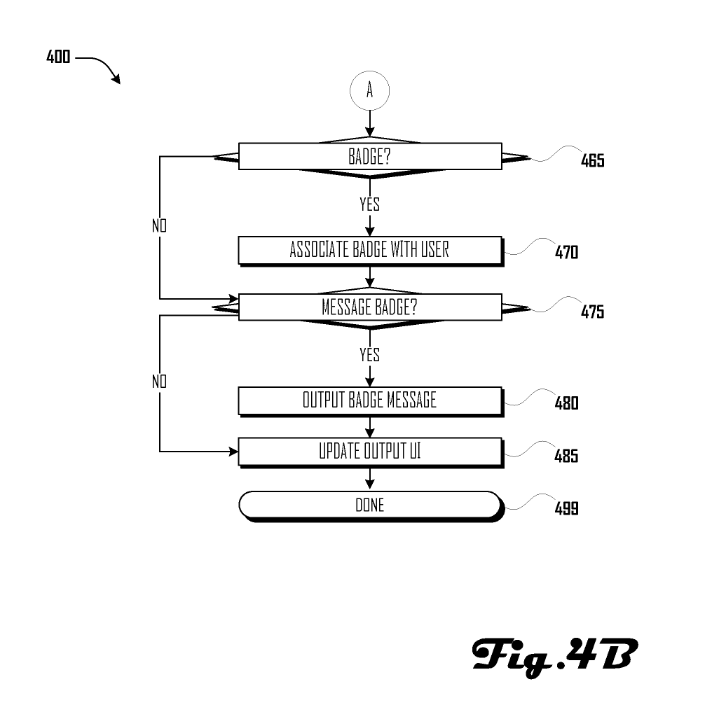

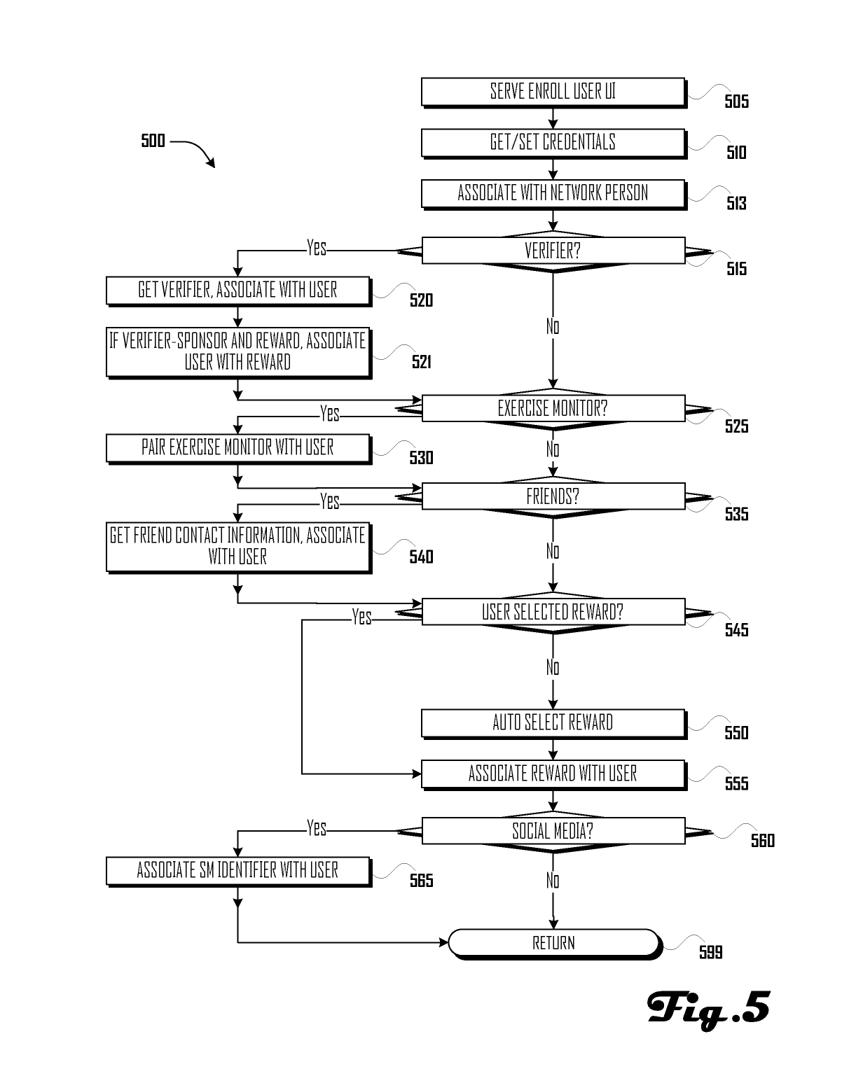

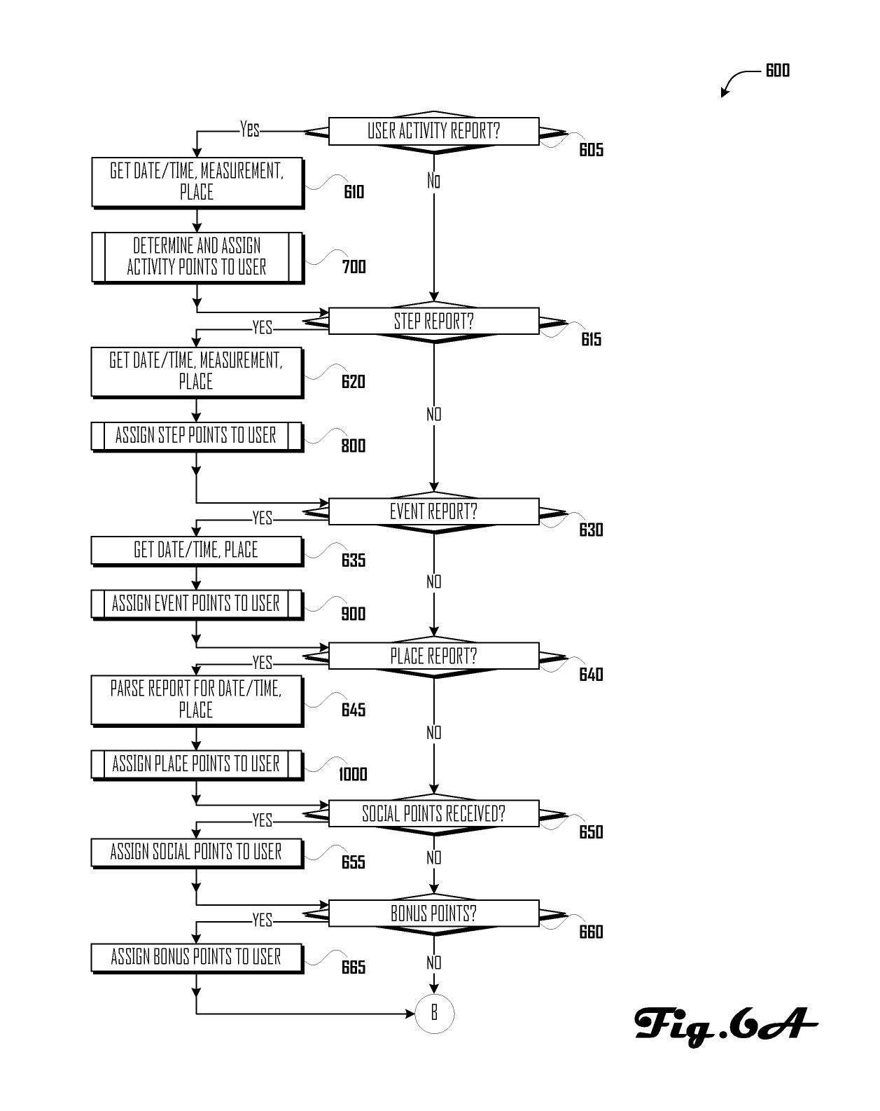

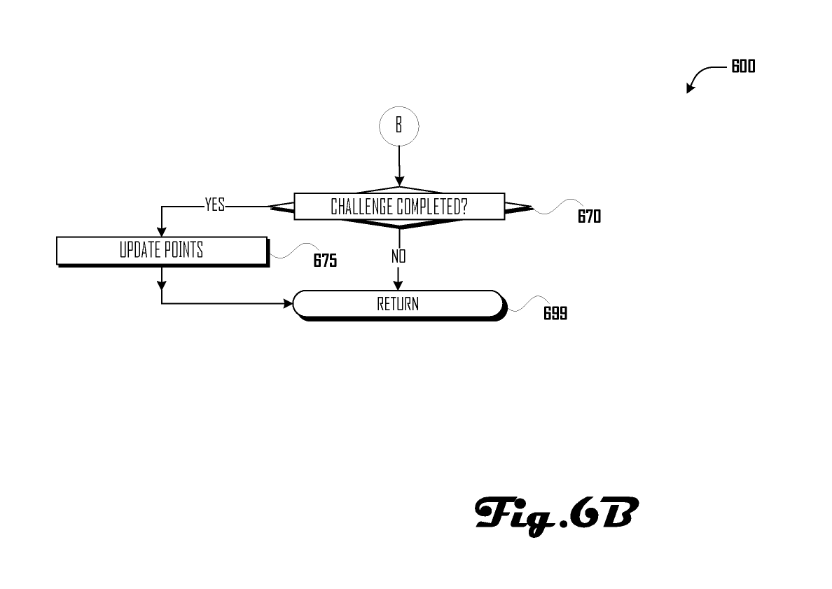

Broadly, EveryMove Server 200 executes Enroll User and Determine Points 400 routine, described further in relation to FIGS. 4A and 4B. Among other processes, Enroll User and Determine Points 400 routine executes Manage User Routine 500, described further in FIG. 5, and Determine Points Routine 600, described further in FIGS. 6A and 6B.

Manage User Routine 500 manages end users and Network Person 307 records associated with end users. Determine Points Routine 600 receives Activity, Step, Place and Event information from the Client Device 105, the Exercise Monitor 110, and the Social Media Server 115. The Activity, Step, Place and Event information is associated with an account associated with Network Person 307. Determine Points Routine 600 assigns Points to the Network Person 307 account based on the Activity, Step, Place and Event information. Determine Points Routine 600 determines points according to Activity Point Routine 700, Step Point Routine 800, Event Point Routine 900, and Place Point Routine 1000.

When the Manage User Routine 500 determines that Network Person 307 has achieved enough Points to earn Reward 335, Network Person 307 is sent Reward 335 redemption instructions, which the user associated with Network Person 307 may use to redeem the Reward 335.

A sponsor assigned Sponsor ID 330 (“Sponsor”) communicates with the EveryMove Server 200 and, for example, the Manager Verifier and Sponsor Routine 1200, via Sponsor Server 125 to sponsor Reward 335. Sponsor may also be a Verifier 120, sponsoring Rewards for members of Verifier 120 organization or Sponsor may be an independent entity.

A verifier assigned Verifier ID 310 (“Verifier”) communicates with EveryMove Server 200 and, for example, the Manager Verifier and Sponsor Routine 1200, via Verifier 120 server. Verifier may be a party such as an employer, a health insurance provider, a gym, or another entity. Manage User Routine 500 may verify the identity of users and Network Person 307 with Verifier 120, to confirm the association between Verifier 120 and the verified Network Person 307 so that Network Person 307 may be offered Reward 335 sponsored by the Verifier, who may also act as a Sponsor, sponsoring Rewards for members of the Verifier's organization.

In FIG. 1, the EveryMove Server 200 is illustrated as comprising computers and software and/or modules for an EveryMove Datastore 300. These may be physically separate computing devices or logically separate processes executed by a common computing device. These components are illustrated in FIG. 1 as connecting directly to one another (such as, for example, an Ethernet connection and/or, if embodied in one computer, via the Bus 220), though the connections may be through the Network 150. Additional steps may be added to the disclosed invention to recite communicating between the components.

The Client Device 105 is illustrated in FIG. 1 as an example of any computing device used by an individual and may be, for example, a mobile computer (such as a mobile “smart” phone, a tablet, or laptop computer), a personal computer, a gaming computer, and/or an Internet-enabled television, or similar device. The Client Device 105 and Exercise Monitor 110 are used by “users” or “end users”.

The Exercise Monitor 110 may be a device which records the physical activity of a user and which reports the physical activity to the EveryMove Server 200; the reported information may comprise a number of steps, rate of steps, time and date, direction, acceleration, and speed, location (including GPS or address information), heart rate, calories expended, an identifier of the Exercise Monitor 110, and credentials. Examples of Exercise Monitor 110 comprise pedometers, microphones, thermometers, and heart, blood, oxygen, breathing, sleeping and other bodily function monitoring equipment, swimming and running and similar training equipment, and the like.

The Social Media Server 115 illustrated in FIG. 1 may provide social media services, such as a forum for users to post and share information regarding, for example, activities, locations at which the user may have been or is expected to be, and information from, for example, Exercise Monitor 110. The information posted to and made available by the Social Media Server 115 may comprise geo-tagged photographs (photographs with associated location information) and photographs associated with the identity of individuals recognized by people and/or face recognition algorithms. The Social Media Server 115 generally allows authorized users and Determine Points Routine 600, to obtain and/or provide information regarding individuals and users of the social media services offered by the Social Media Server 115. Examples of social media services include Twitter, Facebook, Strava, RunKeeper, GolfNet, Nike+, and Foursquare.

The Network 150 comprises computers, network connections among the computers, and software routines to enable communication between the computers over the network connections. Examples of the Network 150 comprise an Ethernet network, the Internet, and/or a wireless network, such as a GSM, TDMA, CDMA, EDGE, HSPA, LTE or other network provided by a wireless service provider. Connection to the Network 150 may be via a Wi-Fi connection. More than one network may be involved in a communication session between the illustrated devices. Connection to the Network 150 may require that the computers execute software routines which enable, for example, the seven layers of the OSI model of computer networking or equivalent in a wireless phone network.

This paper may discuss a first computer as connecting to a second computer (such as a Client Device 105 connecting to the EveryMove Server 200) or to a corresponding datastore (such as to EveryMove Datastore 300); it should be understood that such connections may be to, through, or via the other of the two components (for example, a statement that a computing device connects with or sends data to the EveryMove Server 200 should be understood as saying that the computing device may connect with or send data to the EveryMove Datastore 300). References herein to “database” should be understood as equivalent to “Datastore.” Although illustrated as components integrated in one physical unit, the computers and databases may be provided by common (or separate) physical hardware and common (or separate) logic processors and memory components. Though discussed as occurring within one computing device, the software routines and data groups used by the software routines may be stored and/or executed remotely relative to any of the computers through, for example, application virtualization.

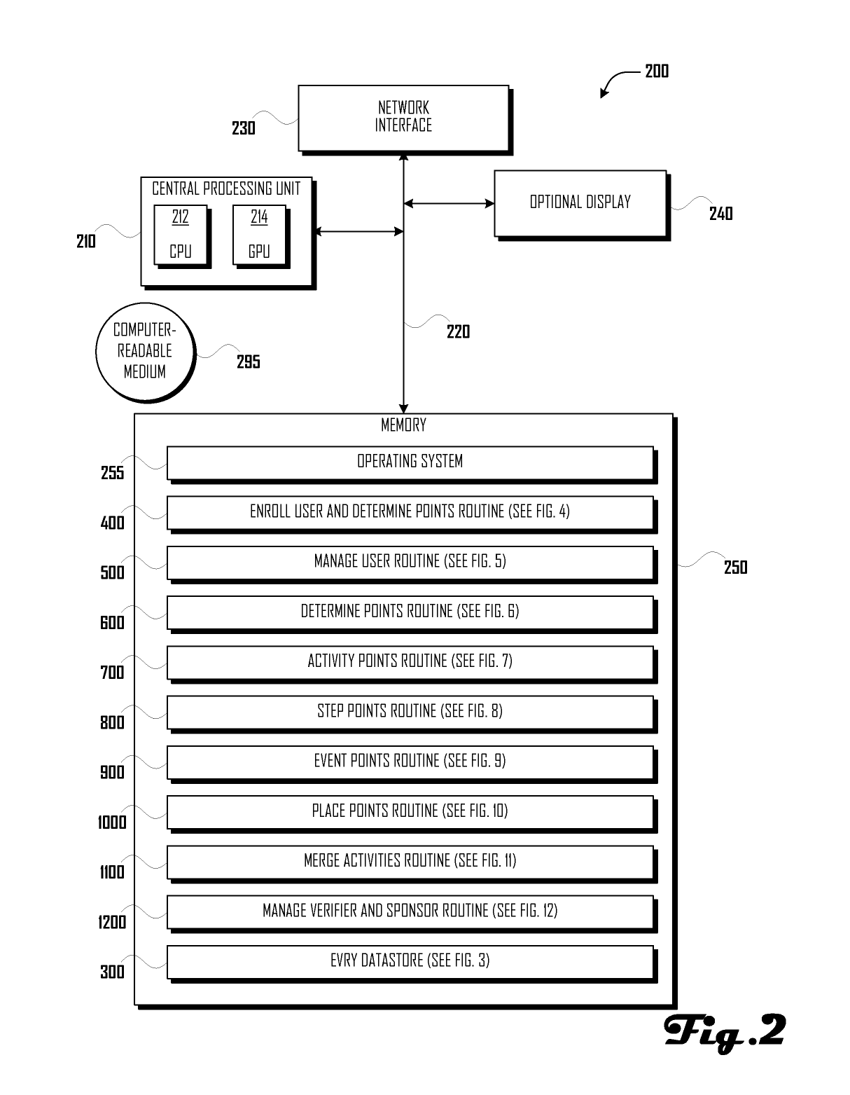

FIG. 2 is a functional block diagram of an exemplary EveryMove Server 200 computing device and some data structures and/or components thereof. The EveryMove Server 200 comprises at least one Processing Unit 210, EveryMove Server Memory 250, a Display 240 and Input 245, all interconnected along with the Network Interface 230 via a Bus 220. The Processing Unit 210 may comprise one or more general-purpose Central Processing Units (“CPU”) 212 as well as one or more special-purpose Graphics Processing Units (“GPU”) 214. The components of the Processing Unit 210 may be utilized by the Operating System 255 for different functions required by the routines executed by the EveryMove Server. The Network Interface 230 may be utilized to form connections with the Network 150 or to form device-to-device connections with other computers. The EveryMove Server Memory 250 generally comprises a random access memory (“RAM”), a read only memory (“ROM”), and a permanent mass storage device, such as a disk drive or SDRAM (synchronous dynamic random-access memory). The EveryMove Server Memory 250 stores program code for software routines, such as, for example, Manage User Routine 500, Determine Points Routine 600, Activity Points Routine 700, Step Points Routine 800, Event Points Routine 900, Place Points Routine 1000, Merge Activities Routine 1100, and Manage Verifier and Sponsor Routine 1200, as well as, for example, browser, email client and server routines, client applications, and database applications (discussed further below). Additional data groups for routines, such as for a webserver and web browser, may also be present on and executed by the EveryMove Server 200. Webserver and browser routines may provide an interface for interacting with the other computing devices illustrated in FIG. 1 or with other computing devices not illustrated in FIG. 1, for example, through webserver and web browser routines (which may serve and respond to data and information in the form of webpages and html documents or files). The browsers and webservers are meant to illustrate user-interface and user-interface enabling routines generally, and may be replaced by equivalent routines for serving and rendering information to and in a user interface in a computing device (whether in a web browser or in, for example, a mobile device application).

In addition, the EveryMove Server Memory 250 also stores an Operating System 255. These software components may be loaded from a non-transient Computer Readable Storage Medium 295 into EveryMove Server Memory 250 of the computing device using a drive mechanism (not shown) associated with a non-transient Computer Readable Storage Medium 295, such as a floppy disc, tape, DVD/CD-ROM drive, memory card, or other like storage medium. In some embodiments, software components may also or instead be loaded via a mechanism other than a drive mechanism and Computer Readable Storage Medium 295 (e.g., via Network Interface 230).

The computing device 200 may also comprise hardware supporting input modalities, Input 245, such as, for example, a touchscreen, a camera, a keyboard, a mouse, a trackball, a stylus, motion detectors, and a microphone. The Input 245 may also serve as a Display 240, as in the case of a touchscreen display which also serves as Input 245, and which may respond to input in the form of contact by a finger or stylus with the surface of the Input 245.

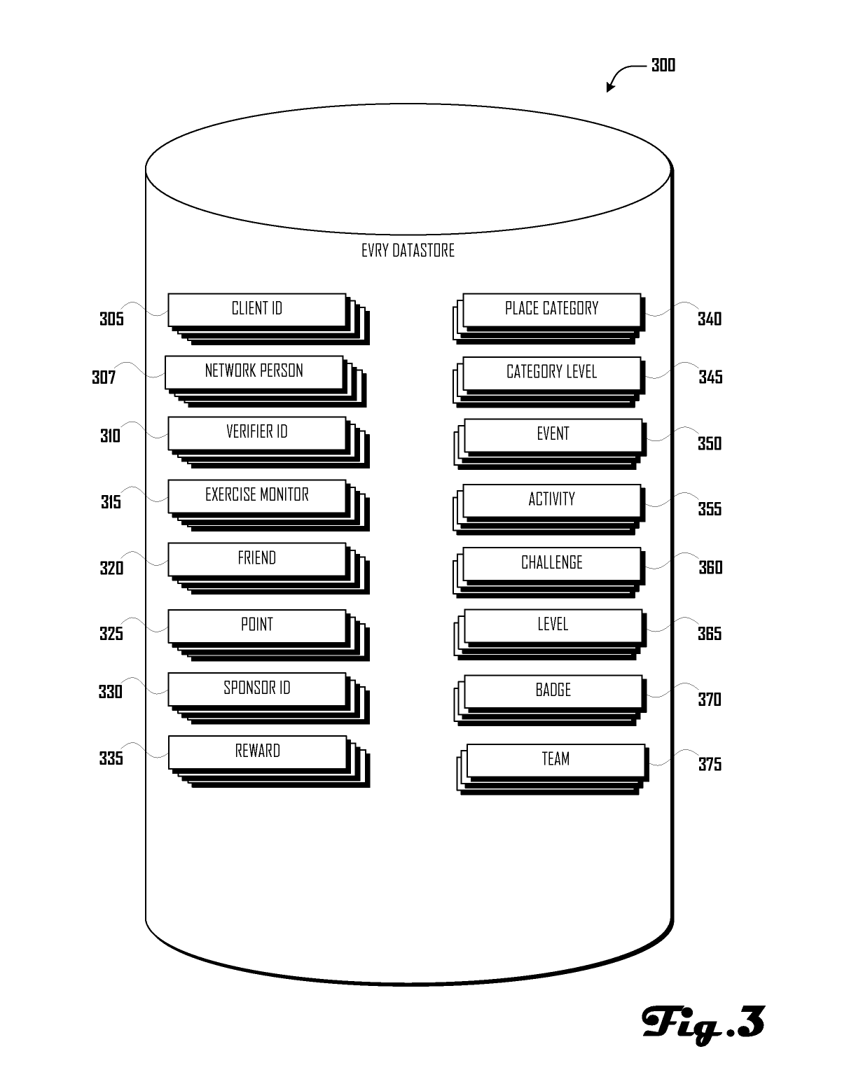

The computing device 200 may also comprise or communicate via Bus 220 with EveryMove Datastore 300, illustrated further in FIG. 3. In various embodiments, Bus 220 may comprise a storage area network (“SAN”), a high speed serial bus, and/or via other suitable communication technology. In some embodiments, the EveryMove Server 200 may communicate with the EveryMove Datastore 300 via Network Interface 230. The EveryMove Server 200 may, in some embodiments, include many more components than those shown in this Figure. However, it is not necessary that all of these generally conventional components be shown in order to disclose an illustrative embodiment.

FIG. 3 is a functional block diagram of the EveryMove Datastore illustrated in the computing device of FIG. 2. The components of the EveryMove Datastore 300 are data groups used by routines. The data groups used by routines illustrated in FIG. 3 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and similar. The components of the EveryMove Datastore 300 are discussed further herein in the discussion of other of the Figures, though a summary of each follows, below.

Generally, Client ID 305 records may comprise entries indicating an identifier assigned to a user, account login credentials associated with a user, contact information provided by a user, and partial or complete identifiers of the user, which identifiers may correspond to identifiers of individuals at Verifier 120. Without limitation, Client ID 305 records may be associated with Network Person 307 records, Verifier ID 310 records, Exercise Monitor 315 records, Friend 320 records, Point 325 records, Reward 335 records, and Event 350 records.

Network Person 307 records may comprise entries which indicate that one or more Client ID 305 records are to be represented as one person or one entity. For example, one user may have created three Client ID 305 records. One Client ID 305 record may have been created at one time using a personal email address. A second Client ID 305 record may have been created at a second time using a work email address. A third Client ID 305 record may have been created at a third time using a second work email address. All three Client ID 305 records may be associated with one Network Person 307 record, so that the same user interface is presented to the user, regardless of the login which the user may use (whether a login associated with the first, second, or third Client ID 305 record). Alternatively, a group of people may wish to share one “user” in the EveryMove method and system, so the Client IDs 305 of the people in the group may all be associated with one Network Person 307, allowing the group to all login as the one “user” associated with the one Network Person 307 record.

Verifier ID 310 records may comprise entries indicating an identifier assigned to a Verifier, account login credentials associated with a Verifier, and contact information provided by a Verifier. Without limitation, Verifier ID 310 records may be associated with Client ID 305 records, Network Person 307 records, with Sponsor ID 330 records, and with Reward 335 records.

Exercise Monitor 315 records may comprise entries indicating an identifier assigned to or provided by an Exercise Monitor 110, the type of equipment and/or monitoring services of or provided by the Exercise Monitor 110, and information reported to the EveryMove Server 200 by the Exercise Monitor 110. Without limitation, Exercise Monitor 315 records may be associated with Client ID 305 records and Network Person 307 records.

Friend 320 records may comprise entries identifying friends associated with a user, contact information of such friends (including contact information at the EveryMove Server 200 and/or at Social Media Server 115), and the like. Without limitation, Friend 320 records may be associated with Client ID 305 records and Network Person 307 records.

Point 325 records may comprise entries indicating a number of Points earned or available to be earned by a user, the type of Point (such as Activity Point, Step Point, Event Point, Place Point, Social Point, and Bonus Point), the time and date earned, and the basis for calculating the Point. Without limitation, Point 325 records may be associated with Client ID 305 records, Network Person 307 records, Reward 335 records, Category Level 345 records, and Event 350 records.

Sponsor ID 330 records may comprise entries indicating an identifier assigned to a Sponsor 125, account login credentials associated with a Sponsor 125, contact information provided by a Sponsor 125, Rewards sponsored by a Sponsor 125 (which records may associate the Sponsor 125 with a Reward 335), consideration paid or offered by a Sponsor 125 for a Reward, Verifier 120 records, and the like. Without limitation, Sponsor ID records may be associated with Reward 335 records and Event 350 records.

Reward 335 records may comprise entries indicating a Reward and a time and date. Without limitation, the Reward 335 records may be associated with Client ID 305 records, Network Person 307 records, Point 325 records, and Sponsor ID 330 records. Examples of Rewards include merchandise, a membership in a club or organization, a coupon, discount, or rebate for purchase of merchandise or a membership, a donation to a charitable organization, cash, or the like. Rewards may also comprise entry in a lottery or drawing for a high-value prize. Rewards may also be tied together, such that earning Reward A makes the user eligible to select Reward B. Rewards may be provided by third parties, such as through the Manage Verifier and Sponsor Routine 1200.

Place Category 340 records may comprise entries indicating locations and one or more categories assigned to the locations. Without limitation, Place Category 340 records may be associated with Category Level 345 records; the Place Categories 340 may be obtained by the EveryMove Server 200 from, for example, a Social Media Server 115 such as, for example, Foursquare™.

Category Level 345 records may comprise entries indicating a level assigned to a Place Category 340 record, such as, for example, levels one through four, wherein level four indicates a place with a high-correlation with physical activity (like a gym), level three indicates a place where some physical activity takes place or is correlated with a healthy activity, level two indicates a place where people tend to walk a relatively large amount (such as a zoo), and level one indicates all other places. Without limitation, Category Level 345 records may be associated with Place Category 340 records.

Event 350 records may comprise entries indicating an Event at a date, time and place, attendance at which will earn a user Event Points. Examples of Events include, without limitation, walk-athons, meetings, lectures or talks, concerts, exercise classes, and the like. Without limitation, Event 350 records may be associated with Client ID 305 records, Network Person 307 records, Verifier ID 310 records, Friend 320 records, Point 325 records, Sponsor ID 330 records, Place Category 340 records, and Category Level 345 records.

Activity 355 records may comprise entries indicating a type of Activity (such as running, yoga, pilates, bicycling, walking, skating, bowling, and the like), measurements associated with the Activity (such as time, steps, distance, and the like), MET values associated with the Activity, and the like. Without limitation, Activity 355 records may be associated with Client ID 305 records and Network Person 307 records.

Challenge 360 records may comprise entries defining the objective of a Challenge. Examples of Challenge objectives include, without limitation, an offer that, in exchange for obtaining a certain number of Points, a party will make a donation to a charitable entity (selected by a user or by another), or that for completing an Activity with a specified duration, or within a certain time period, or for referring a certain number of users to the system, the user completing the Challenge will receive a certain number of Points, or a Reward, or an opportunity to win Points or a Reward in a drawing, or a cash payment. Challenge 360 records may indicate a Team 375 comprising a set of users who must individually or collectively complete the Challenge objective. Without limitation, Challenge 360 records may be associated with Client ID 305 records, Network Person 307 records, Sponsor ID 330 records, Reward 335 records, Point 325 records, and Team 375 records.

Level 365 records may comprise entries defining a Level assigned to a user. A default Level, such as “Level 1,” may be assigned to all users. Subsequent levels, such as “Level 2,” etc., may be achieved by, for example, earning Points, either across the entire span of time a user is associated with the system or for earning a number of Points within a time period. Rewards may be determined, in part, by the Level of the user who achieved the Reward. Without limitation, Level 365 records may be associated with Client ID 305 records, Network Person 307 records, and Reward 335 records.

Badge 370 records may comprise entries which recognize accomplishments, such as obtaining a certain number of Points, being an active participant for a period of time, completing certain Activities or a certain number of Activities (including a certain number of Activities within a period of time), or the like. Users may share achievement of Badges on social media, such as on Social Media Server 115.

Team 375 records may comprise entries which identify two or more users who must or may participate in a Challenge or who may otherwise work together to achieve a Reward.

FIGS. 4A and 4B are a flowchart illustrating an example of Manage User and Determine Points Routine 400. At block 500 in FIG. 4A, the Manage User Routine 500 is performed. This is discussed in greater detail with respect to FIG. 5. Generally, at this block, a user is registered or enrolled with or by Manage User Routine 500 and assigned or associated with a Client ID 305 record and a Network Person 307 record, a Verifier 120 is associated with the Client ID 305 record via association with a Verifier ID 310 record, an Exercise Monitor 110 is associated with the Client ID 305 record via association with an Exercise Monitor 315 record, a Friend 320 record is associated with the Client ID 305 record, a Reward 335 record is associated with the Client ID 305 record, and an Activity 355 record is associate with the Client ID 305 record.

At block 600 in FIG. 4A, the Determine Points Routine 600 is performed. This is discussed in greater detail with respect to FIGS. 6A and 6B. Generally, at this block, Determine Points Routine 600 receives Activity, Step, Event, Place Reports, determines a number of Points for each and associates the determined Points with the Client ID 305 record, and determines if Social Points, Bonus Points, and/or Challenge Points have been earned by or given to the user and associates the Points with Client ID 305 record.

At block 405, Manage User and Determine Points Routine 400 outputs a user interface to the Client Device 105 associated with Client ID 305 record, which user interface comprises information obtained from the Point 325 and Reward 335 records associated the Client ID 305 record, including Rewards available to the user and Points needed to redeem the Rewards. The user interface may also comprise Social Points which the user may share with others (discussed below), Challenges which are available to the user and which the user is participating in.

At block 410, Manage User and Determine Points Routine 400 determines whether sufficient Points have been earned for the user associated with the Client ID 305 record to receive the Reward of Reward 335 record of block 555. If negative, the next decision block may be executed.

If affirmative at block 410, at block 415, Manage User and Determine Points Routine 400 may make the Reward available to the user, such as by notifying the user by updating the user interface served to the user.

At block 420, Manage User and Determine Points Routine 400 notes that the Points required to redeem the Reward are no longer available to redeem other rewards, such as by updating the Point 325 records associated with the Client ID 305 associated with the user.

At block 425, Manage User and Determine Points Routine 400 may implement the Reward, such as if the Reward is a contribution to a charitable organization, if the Reward requires the purchase of goods and/or services and/or a credit toward the purchase of goods and/or services, if the Reward requires notifying a Sponsor 125 and/or a Verifier 120 of a discount which the user is entitled to as part of the Reward, or the like.

At block 430, Reward redemption instructions may be sent to the Client Device 105; the Reward redemption instructions may comprise a link to a webpage with a coupon, a webpage with confirmation that the goods and/or services were purchased, and/or a webpage with confirmation that a discount has been applied, or the like.

At block 435, a determination may be made regarding whether the user has shared Social Points. As discussed herein, when a user achieves an objective such as earning an Active Day Bonus or a Very Active Day Bonus, or upon achieving other objectives, the user may earn a number of Points which the user can distribute to friends, such as friends associated with a Friend 320 record, which Points are referred to as Social Points. For example, an Active Day Bonus may allow a user to allocate 5 points among or to three friends while a Very Active Day Bonus may allow a user to allocate 8 points among or to three friends. If so, then at block 655, the Social Points may be assigned to the user, such as by updating the Point 325 record associated with the Client ID 305. A user may share Social Points by an indication in the user interface served to the user. If negative at block 435, the next decision block may be executed.

At block 440, Manage User and Determine Points Routine 400 may send a message to the recipient of the Social Points that the Social Points have been shared by the user. See, for example block 650.

At block 445, Manage User and Determine Points Routine 400 may determine if an available Challenge 360 has been accepted by the user, such as via interaction by the user with the user interface. If negative at block 445, the next decision block may be executed.

At block 450, if affirmative at block 445, then the user may be associated with the accepted Challenge 360 and, if applicable, a Team 375, such as via an association between Challenge 360, Team 375, and User ID 305.

At block 455, Manage User and Determine Points Routine 400 may determine if the user has experienced a change in Level 365, such as if the User has obtained a number of Points 325 or another prerequisite for changing to a different Level 365. If negative at block 455, the next decision block may be executed.

If affirmative at block 455, then at block 460, User ID 305 may be associated with the updated Level 365.

At block 465, Manage User and Determine Points Routine 400 may determine whether a Badge 370 has been earned by the user, such as by determining whether the User ID 305 is associated with achieving objectives of the Badge 370, such as a number of Activities within a period of time, a number of Points within a period of time, association with an Event 350, or the like. If negative at block 465, the next decision block may be executed.

If affirmative at block 465, then at block 470 Badge 370 may be associated with User ID 305.

At block 475 Manage User and Determine Points Routine 400 may determine whether the user has provided an indication to the user interface to share Badge 370 of block 470, such as by sending Batch 370 or information regarding Badge 370 in a message. If negative at block 475, the next decision block may be executed.

If affirmative at block 475, then at block 480 Manage User and Determine Points Routine 400 may output a share Badge message, such as by posting a graphic and text associated with Badge 370, along with text provided by the user, to, for example, Social Media Server 115, and/or to an email address or other contact information associated with a recipient of the shared Badge 370.

At block 485, if not already performed during performance of the preceding blocks, Manage User and Determine Points Routine 400 may update the user interface according to the result of the preceding blocks.

At block 499 the process may end or may return to an earlier step, such as to block 500.

FIG. 5 is a flowchart illustrating an example of a Manager User Routine 500. At block 505, Manage User Routine 500 may serve a user interface to the Client Device 105, to enroll or register a user of the Client Device 105 with Manage User Routine 500. At block 510, Manage User Routine 500 may receive credentials from the user of the Client Device 105, such as a user-name, password, and/or email address or other contact information and/or Manage User Routine 500 may receive authorization to enroll the user with respect to Manage User Routine 500 based on the user's registration with a social media service, as may be provided or confirmed by or with Social Media Server 115. Manage User Routine 500 may then associate a Client ID 305 with the user. The Client ID 305 may comprise or be associated with the user credentials, such as the login ID, password, email address, or other credentials and/or contact information provided by the user. The user may then input the credentials into the user interface to log in to Manage User Routine 500 and be associated with the Client ID 305.

At block 513, Manage User Routine 500 may associate the Client ID 305 with a Network Person 307 record. The Network Person 307 record may allow multiple users or multiple Client IDs 305 to be associated with one record, as may be desirable when one user has multiple log-in identifiers or when multiple users are to be associated with one log-in with the Manage User Routine 500. Block 513 may be performed by asking the user for confirmation and/or through an identification request, such as by emailing a confirmation request to an email address associated with a previously created Client ID 305 records. References herein to Client ID 305 or to “a user” should generally be understood to refer to Network Person 307.

At block 515, Manage User Routine 500 may determine whether the user is to be associated with a Verifier, such as via Verifier 120 record. This block may be performed by obtaining Verifier information from the user. The Verifier's information may be, for example, an email address used by the user, which email address has a uniform resource indicator or locator (“URI” or “URL”) which is already associated with a Verifier, such as via a Verifier ID 310. As another example of a confirmation step, a Verifier 120 associated with a Verifier ID 310 may provide to the EveryMove Server 200 and Manage Verifier and Sponsor Routine 1100 a list of user names or a list of email addresses or other authentication criteria of users who Verifier 120 will act as a verifier for.

At block 520, upon affirmative confirmation via email with the user or following another confirmation step, Manage User Routine 500 may associate Verifier ID 310 with Client ID 305. At block 521, if Verifier 120 associated with Verifier ID 310 is also a Sponsor 125 and sponsors Reward 335 for the verified user, then Manage User Routine 500 may associate Reward 335 with Client ID 305 and make the Reward available to be earned by the user.

At block 525, which may not necessarily follow block 515 (blocks 515, 525, 535, and 545 may follow a different order than the one illustrated), Manage User Routine 500 may determine whether the user has provided an indication that the user will provide information for Exercise Monitor 110, which Exercise Monitor 110 is to be paired to the user and the user's Client ID 305 (or Network Person 307).

If affirmative at block 525, then at block 530 Manage User Routine 500 may obtain Exercise Monitor's 110 information from the user and/or from Exercise Monitor 110. Manage User Routine 500 may request that the user connect the Exercise Monitor 110 to the Network 150 and/or may provide the user with connection information to allow the user to connect Exercise Monitor 110 to Manage User Routine 500 and/or Manage User Routine 500 may request or otherwise obtain information which Manage User Routine 500 may use to obtain information from Exercise Monitor 110, either directly or through a service to which Exercise Monitor 110 may connect and upload information to. Manage User Routine 500 may create an Exercise Monitor 315 record, which record Manage User Routine 500 may associate with Client ID 305 of the user, such that Manage User Routine 500 can associate information from Exercise Monitor 315 with Client ID 305 (or Network Person 307).

At block 535, Manage User Routine 500 may determine whether the user has provided an indication that the user will provide information regarding a friend of the user, which friend may be assigned a Friend 320 record, which Friend 320 record may then be associated with Client ID 305.

If so, then at block 540 Manage User Routine 500 may obtain the friend's contact information from the user; the contact information may comprise an email address for the friend, an identifier of the friend in a social media service, or similar. Manage User Routine 500 may confirm the relationship; such confirmation may be via or through an email and/or via or through Social Media Server 115. Manage User Routine 500 may associate the friend with a Friend 320 record and associate the Friend 320 record with the Client ID 305 of the user.

At block 545, Manage User Routine 500 may determine whether the user has provided an indication that the user will select a Reward associated with, for example, Reward 335 record, which Reward 335 record is to be associated Client ID 305. Selectable Rewards may be presented to the user via the user interface.

At block 550, if negative at block 545, Manage User Routine 500 may optionally automatically select a Reward 335 record to associate with the user. Automatic selection of a Reward may be according to, for example, a Level of the user, a geographic location of the user, Verifier(s) associated with the user, a Challenge associated with the user, or the like.

At block 555, which may follow from a user selection of a Reward or from an automatic selection of a Reward, Manage User Routine 500 may associate the Reward 335 record with Client ID 305.

At block 560, Manage User Routine 500 may determine whether one or more Social Media Servers 115 are associated with the user. If affirmative, then at block 565, an account identifier and, optionally, access permission of the user at the Social Media Server 115 may be obtained. The account identifier and optional access permission may be used to obtain Activity Reports from the Social Media Server 115.

At block 599, the process may return to FIG. 4A.

FIGS. 6A and 6B are a flowchart illustrating an example of a Determine Points Routine 600.

At block 605, Determine Points Routine 600 may determine whether Determine Points Routine 600 will receive an Activity Report from, for example, the user (via, for example, a user interface), Social Media Server 115, Exercise Monitor 110, or the like. An Activity Report may comprise information from or about the user that the user has engaged in an Activity. Activity and Activity Reports may be recorded in Activity 355 records. Activities may include, for example, bicycling, running, yoga, pilates, jumping rope, swimming, lifting weights, skating, bowling and the like.

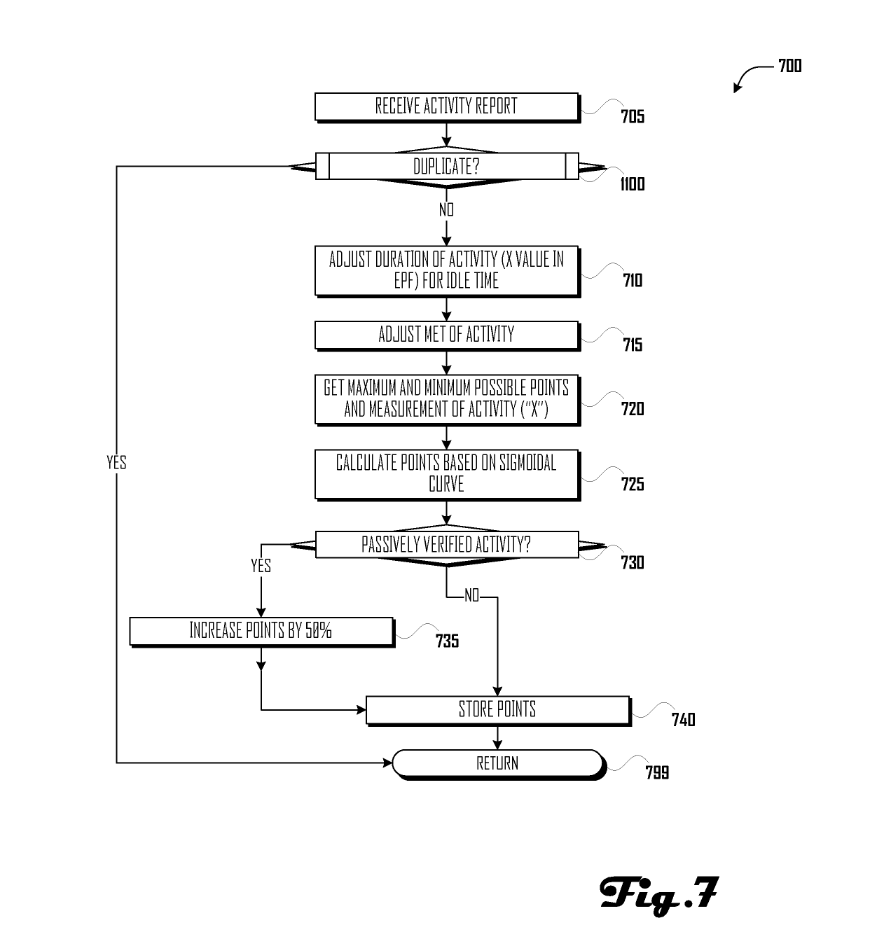

At block 610, Determine Points Routine 600 gets or parses the Activity Report for the date/time of the activity, any measurement information related to the activity (such as a distance, a temporal duration of the activity, and the like), a place where the activity occurred, and the like. At block 700, discussed further in relation to FIG. 7, Activity Points Routine 700 determines the number of Points for the Activity and assigns Activity Points to the user, such as by updating Point 325 record associated with Client ID 305.

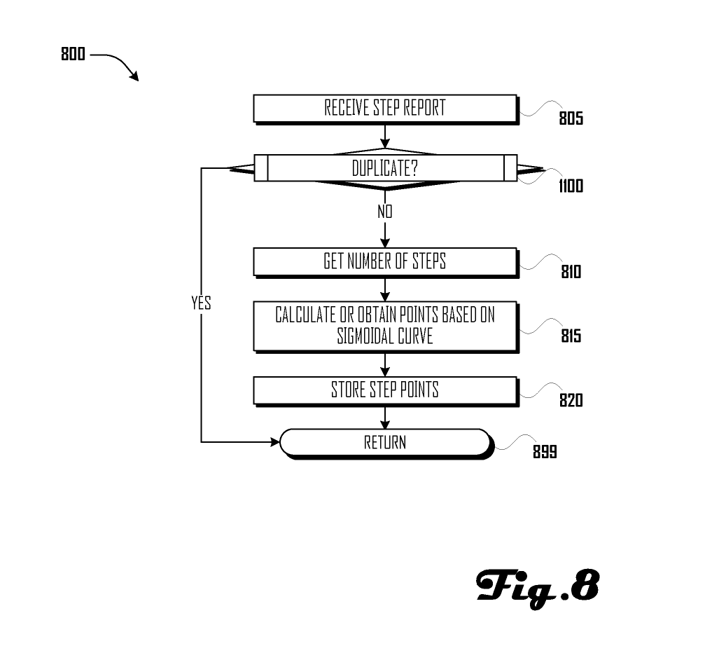

At block 615, Determine Points Routine 600 may determine whether it has received a Step Report from the Exercise Monitor 110 associated with Exercise Monitor 315 record. The Exercise Monitor 110 may report, for example, a number of steps, an amount of swimming, metabolic activity, a date/time, a place, and/or other monitored activities or information. At block 620, Determine Points Routine 600 gets or parses the date/time of the activity, any measurement information related to the activity (such as a distance, a temporal duration of the activity, and the like), a place where the activity occurred, and/or other information which may be provided by the Exercise Monitor 315 in the Step Report. At block 800, discussed further in relation to FIG. 8, Step Points Routine 800 determines the number of Step Points for the activity and assigns Step Points to the user, such as by updating the Point 325 record associated with the Client ID 305.

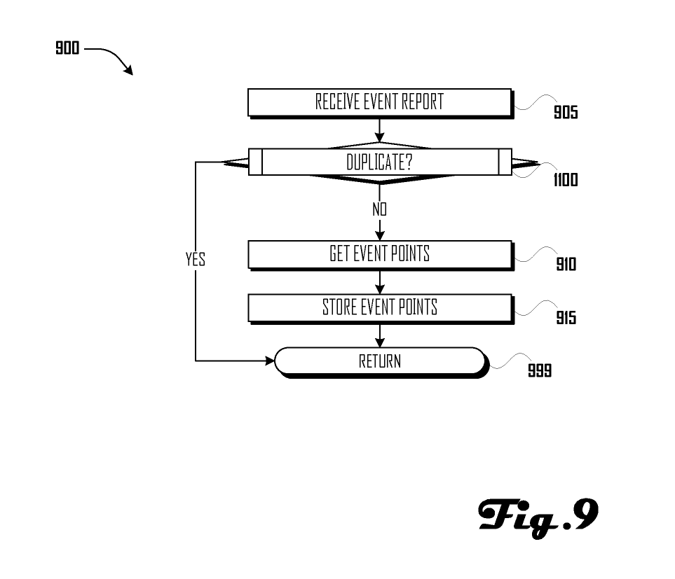

At block 630, Determine Points Routine 600 may determine whether it has received an Event Report from, for example, Sponsor 125, Third Party Server 130, or Social Media Server 115. The Event may be a sporting, networking, or other event, registration for or attendance at which entitles users confirmed to have registered for or attended the Event to Event Points. The Event may be registered with the EveryMove Server 200, such as by Sponsor 125 via Manage Verifier and Sponsor Routine 1200, and may have been assigned an Event 350 record, which Event 350 record may be associated with a Point 325 record. If so, then at block 635, Determine Points Routine 600 may get the date/time, place, identifiers of users and/or other information from the Event Report and/or from the Event 350 record. At step 900, discussed further in relation to FIG. 9, Event Points Routine 900 determines the number of Event Points for the activity and assigns Event Points to the user, such as by updating the Point 325 record associated with the Client ID 305.

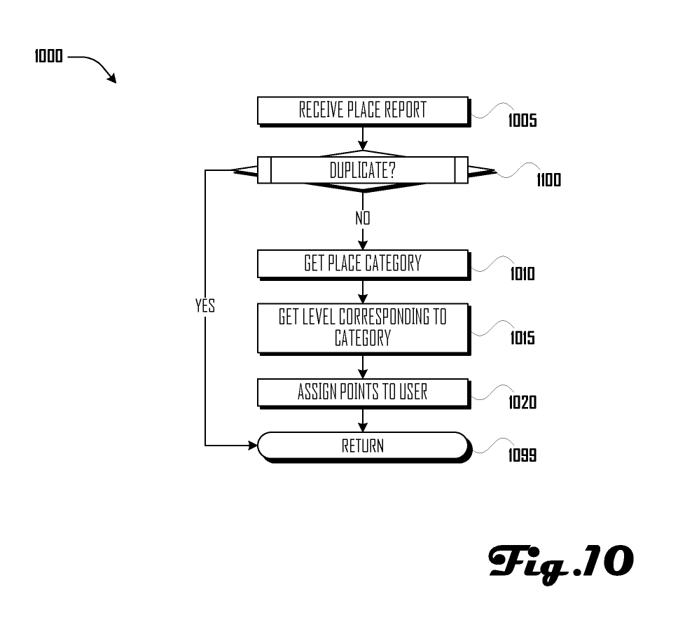

At block 640, Determine Points Routine 600 may determine whether it has received a Place Report from, for example, a user, Sponsor 125, Third Party Server 130, or Social Media Server 115. The Place Report may indicate the user's presence at a location at which healthy activities are known to occur. The Place Report may be received following a user check-in at the location via a social media service, such as a Foursquare, Facebook, Yelp, or Gowalla check-in at or with Social Media Server 115, which check-in may generate a social media update relating to the user to which Determine Points Routine 600 subscribes. The Place Report may comprise a geo-tagged update or photograph in a social media service. The Place Report may comprise MMS or SMS contact with or from a social media service, such as BizeeBee, MindBody, Daskos, or the like. The Place Report may comprise the user recording a contact with a QR code, RFID or the like at the location. The Place Report may not be designated as such by the reporting entity, but may be part of the information feed relating to the user from the social media service. At block 645, the Place Report may be parsed to identify the location and the date/time at which the user was at the location. Parsing the Place Report may be performed with reference to Place Category 340 records, which records may identify locations and categories associated with such locations. At step 1000, discussed further in relation to FIG. 10, the Place Points Routine 1000 determines the number of Place Points for the user being at the location and assigns Place Points to the user, such as by updating the Point 325 record associated with the Client ID 305.

At block 650, Determine Points Routine 600 may determine whether Social Points have been received in relation to the user associated with Client ID 305. As discussed herein, when a user achieves an objective such as earning an Active Day Bonus or a Very Active Day Bonus, or upon achieving other objectives, the user may earn a number of Points which the user can distribute to friends, such as friends associated with a Friend 320 record. For example, an Active Day Bonus may allow a user to allocate 5 points among or to three friends while a Very Active Day Bonus may allow a user to allocate 8 points among or to three friends. At block 650, the user may have received Social Points from a friend. If so, then at block 655, the Social Points may be assigned to the user, such as by updating the Point 325 record associated with the Client ID 305.

At block 660, Determine Points Routine 600 may determine whether Bonus Points have been earned by the user associated with Client ID 305. Bonus Points may be earned when the user engages in an “Active Day” or a “Very Active Day.” This may be calculated by determining an Active Daily Score. The Active Daily Score may be determined according to the following formula:

For each Activity Report: (100*the duration of the Activity)/(7,500/(the typical MET for the Activity raised to the second power)),+the number of Steps received in the day from Step Reports/250,+100*(the number of Events),+(10*Level 4 check-ins)+(5*Level 3 check-ins)+(2*Level 2 check-ins).

When the Active Daily Score is 40-79, then the user may earn an “Active Day” Bonus of 25 Points. When the Active Daily Score is 80-100, then the user may earn a “Very Active Day” Bonus of 35 Points.

If so at block 660, then at block 665, the Bonus Points may be assigned to the user, such as by updating the Point 325 record associated with the Client ID 305.

At block 670, Determine Points Routine 600 may determine if a Challenge has been completed, such as by meeting the criteria of a Challenge, according to the Activity Points reported or determined in blocks 605 through 665.

At block 699, the Determine Points Routine 600 may conclude and may then, for example, return to FIG. 4A.

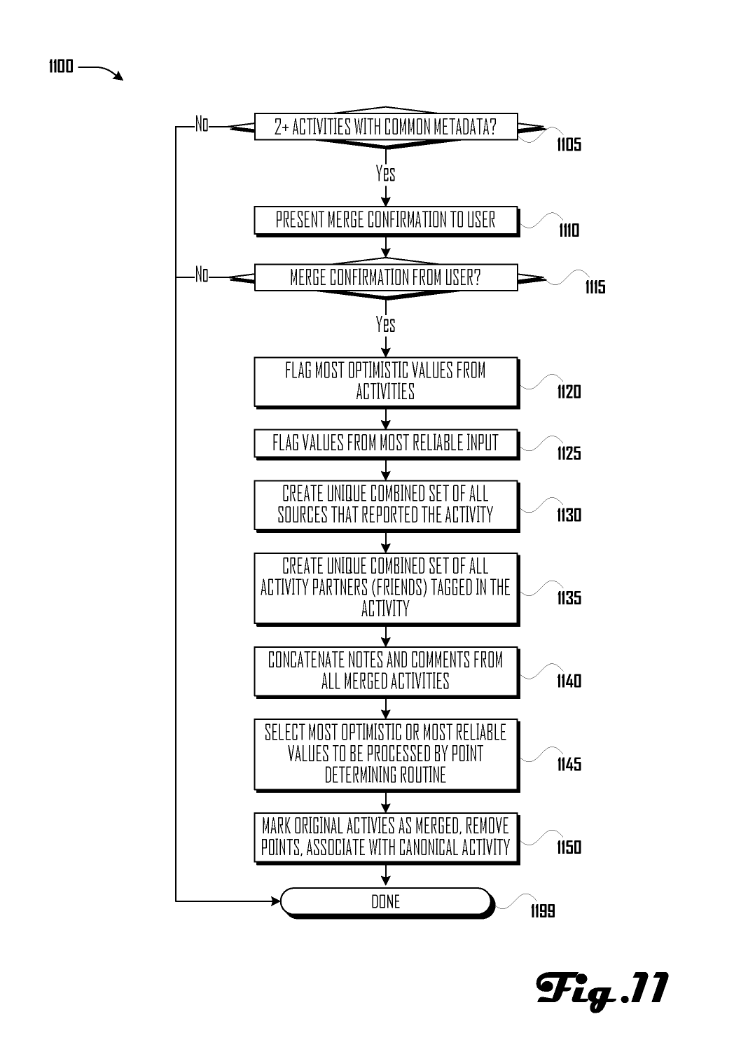

FIG. 7 is a flowchart illustrating an example of an Activity Point Routine 700. At block 705, an Activity Report may be received, such as or according to blocks 605 and 610. At block 1100, the Merge Activities Routine 1100 may determine whether the received Activity Report is a duplicate, such as if two Activity Reports both list the same time, place, activity or other matching criteria. Merge Activities Routine 1100 is discussed at greater length in relation to FIG. 11. If not, then at block 710, the duration of the Activity from the Activity Report may be adjusted. The duration of the Activity is “X” in the “EPF” formula (discussed below). To adjust the duration, the Activity 355 record for the Activity may be obtained and the IdleFactorMinDuration, IdleFactorDecayDuration, and IdleFactorDecayPercent values for the Activity. The following EPF formula may be used to adjust the duration of the Activity.

If ActivityDuration<=IdleFactorMinDuration, then AdjustedDuration=ActivityDuration

If ActivityDuration<=IdleFactorMinDuration+IdleFactorDecayDuration, then AdjustedDuration=IdleFactorMinDuration+(1−IdleFactorDecayPercent) (ActivityDuration/IdleFactorDecayDuration)*(ActivityDuration−IdleFactorMinDuration)

Else, AdjustedDuration=IdleFactorMinDuration+(1−IdleFactorDecayPercent) (ActivityDuration/IdleFactorDecayDuration)*(ActivityDuration−IdleFactorMinDuration)+(ActivityDuration−IdleFactorDecayDuration)*IdleFactorDecayPercent.

At block 715, the MET of the Activity may be adjusted. The MET may be adjusted based on DeviationEffort and StrengthEffort values associated with or obtained from the Activity 355 record for the Activity.

The DeviationEffort is related to how far outside of an ordinary lifestyle the Activity is with respect to the following values:

0.0=The Activity is part of an ordinary lifestyle (mowing the lawn, playing with children, etc.).

1.0=The Activity is done at home but is not part of a typical lifestyle (P90X, Zumba, Kinect, etc.).

2.0=The Activity is typically done outside of the home and requires motivation (biking, crossfit, running, yoga, etc.).

The StrengthEffort is related to additional perceived effort to perform this Activity in addition to the typical MET values for the Activity. Examples of the StrengthEffort values are as follows:

0.0=The Activity carries with it minimal additional perceived effort (running, biking, playing with children, mowing the lawn, etc.).

1.0=The Activity carries with it some additional perceived strength effort (yoga, pilates, etc.).

2.0=The Activity carries with it significant additional perceived strength effort (weight lifting, rowing, etc.).

The formula to adjust the MET of the Activity is as follows:

AdjustedMET=TypicalMET+DeviationEffort+StrengthEffort

For unknown Activities, a default TypicalMET and AdjustedMET of 2.0 may be used. For bicycling and running, a variable MET computation may be used, based on the pace of the activity (a function of the distance and time of the Activity), wherein a faster pace has a higher TypicalMET than a slower pace.

At block 720, the maximum (“MaxPoints”) and minimum (“MinValue”) possible Points to be granted for the Activity are obtained or calculated. Generally the MaxPoints value equals ((7,500/(AdjustedMet raised to the second power))*(Activity units, such as minutes)). Generally the MinValue is 5 Points.

At block 725, the Points for the Activity are calculated based on a Sigmoidal curve. An example of a formula for calculating the Points based on a Sigmoidal curve is as follows:

PointsFunction(X)=MaxPoints−PointsDelta*(1/(0.98+EXP(−4+((X−MinValue)/ValueDelta)*8.5)))

Where:

MaxPoints=Maximum number of points to be granted.

MinPoints=Minimum number of points to be granted.

MinValue=Minimum Data-Value to grant points (granting MinPoints).

MaxValue=Maximum Data-Value to grant maximum points.

PointsDelta=MaxPoints−MinPoints.

ValueDelta=MaxValue−MinValue.

X=The measurement of Activity units (steps, minutes, miles, etc.) In the foregoing, Points are rounded; if X is less than MinValue, then no Point is granted (not MinPoints); if X is greater than MaxValue, then MaxPoints is granted.

At block 730, a determination may be made regarding whether the Activity is passively verified, such as if an Exercise Monitor 110 provided a Step Report at the same or in proximity to the same day/time and/or location as the user Activity Report. If so, then at block 735, the Points may be increased by 50%. At block 740, the Points may be stored and, at block 799, the process may return to FIG. 6A.

FIG. 8 is a flowchart illustrating an example of a Step Point Routine 800. At block 805, a step report may be received, such as according to blocks 615 and 620. At block 1100, the Merge Activities Routine 1100 may determine whether the received Step Report is a duplicate, for example, if multiple Exercise Monitors 110 associated with Client ID 305 submit multiple reports with closely correlated date/time, place, or other information. Merge Activities Routine 1100 is discussed at greater length in relation to FIG. 11. If Step Report is not determined to be a duplicate, then at block 810 the number of steps in the Step Report may be obtained, such as if the Step Report is from a pedometer.

At block 815, the number of Points based on a Sigmoidal curve is calculated or obtained. An example of a formula to calculate the number of Points based on a Sigmoidal curve is as above, in relation to block 725, wherein MinPoints=5,000 and MaxPoints=16,000 and X is equal to the number of steps obtained in block 810. Typical values using this formula and the foregoing constants results in the following Point values for the following number of steps:

5,000 steps=10 Points.

7,000 steps=12 Points.

9,000 steps=21 Points.

10,000 steps=28 Points.

12,000 steps=42 Points.

15,000 steps=49 Points.

At block 820, the Step Points may be stored and, at block 899, the process may return to FIG. 6A.

FIG. 9 is a flowchart illustrating an example of an Event Point Routine 900. At block 905, an Event Report may be received, for according to blocks 630 and 635. At block 1100, the Merge Activities Routine 1100 may determine whether the received Event Report is a duplicate, such as if multiple social media services or other sources report the same Event. Merge Activities Routine 1100 is discussed at greater length in relation to FIG. 11. At block 910 the Event 350 record is obtained and the Points 325 associated therewith are also obtained. At block 915, the Points 325 obtained at block 910 may be stored and, at block 999, the process may return to FIG. 6A.

FIG. 10 is a flowchart illustrating an example of a Place Point Routine 1000. At block 1005, a Place Report may be received, such as according to blocks 640 and 645. At block 1100, the Merge Activities Routine 1100 may determine whether the received Place Report is a duplicate, such as if multiple social media services or other sources report the user at or in proximity to the same Place. Merge Activities Routine 1100 is discussed at greater length in relation to FIG. 11. At block 1010 the Place Category 340 record associated with the location of the Place is obtained. At block 1015 the Category Level 345 associated with the Place Category 340 record of block 1010 may be obtained, which Category Level 345 is associated with a Point 325 record. At block 1020 the Points 325 associated with the Category Level 345 may be stored and, at block 1099, the process may return to FIG. 6A.

FIG. 11 is a flowchart illustrating an example of a Merge Activities Routine 1100. At block 1105, a determination may be made regarding whether two or more Activity Reports associated with a user share common metadata. Criteria for finding shared common metadata may comprise, for example, the same date or time or a date-time within a temporal range, the same place or places within a proximity range, the same type of Activity, the same Exercise Monitor 110, the same amount of an Activity or an amount of Activity within a range, or the like. Determination of shared common metadata may be according to a scoring calculation, in which metadata are weighted, with the weighted scores added, and with a shared status being determined when the score exceeds a threshold. The weighting of metadata may weigh some types of metadata more heavily than others, such as date or date-time being weighted more heavily than other metadata.

At block 1110, a merge confirmation may be presented to the user, requesting that the user confirm whether the Activities should be merged into one. At block 1115 a determination may be made regarding whether the user provided a merge confirmation.

If affirmative at block 1115, then at block 1120 Merge Activities Routine 1100 may flag the most optimistic values from the Activity Reports of block 1105. The most optimistic values may be those which state the most activity. For example, if a first Activity Report states a distance of 4.5 miles, and a second Activity Report states a distance of 5 miles, the “most optimistic value” would be 5 miles.

At block 1125, Merge Activities Routine 1100 may flag the values in the most reliable Activity Report. For example, an Activity Report with passively obtained information, such as from an Exercise Monitor 110 which reports date-time and location may be flagged as being more reliable than a user-reported Activity Report.

At block 1130, Merge Activities Routine 1100 may create a unique combined set of all sources that reported the Activity, such as set comprising a user, an Exercise Monitor 110, a Social Media Server 115, and the like.

At block 1135, Merge Activities Routine 1100 may create a unique combined set of all users or other individuals reported in the Activity, such as Friends, so that all users may be credited for the Activity.

At block 1140, Merge Activities Routine 1100 may concatenate notes and comments from all merged Activity Reports, so that a complete set of information may be reported or output.

At block 1145, the most optimistic or most reliable values flagged in blocks 1120 and/or block 1125 may be selected or identified to be used by Determine Points Routine 600.

At block 1150, Merge Activities Routine 1100 may mark the original Activity Reports as having been merged, may remove Points which were previously awarded for earlier instances of the merged Activity Reports, and may otherwise associate the multiple Activity Reports with one canonical Activity Report.

At block 1199, Merge Activities Routine 1100 may conclude and may return, for example, to a routine which called the Merge Activities Routine 1100.

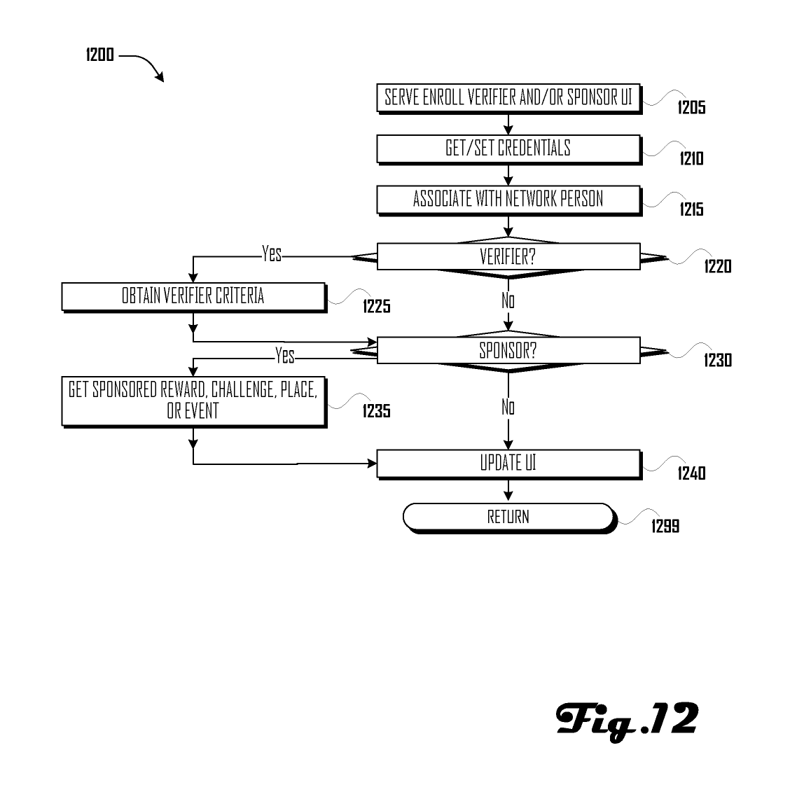

FIG. 12 is a flowchart illustrating an example of a Manage Verifier and Sponsor Routine 1200. At block 1205, Manage Verifier and Sponsor Routine 1200 may serve a user interface to, for example, Verifier 120 and/or Sponsor 125 to associate the party with a Verifier ID 310 and/or Sponsor ID 330 record.

At block 1210, Manage Verifier and Sponsor Routine 1200 may request, receive and/or otherwise set credentials to authenticate and authorize the party as Verifier 120 and/or Sponsor 125. At block 1215, the party may be associated with a Network Person 307 record, to allow multiple login accounts to be associated with one Network Person 307 record.

At block 1220, Manage Verifier and Sponsor Routine 1200 may determine whether the party is being enrolled as a Verifier, such as according to an element in the user interface. If affirmative at block 1220, then at block 1225, Manage Verifier and Sponsor Routine 1200 may obtain verification criteria for users who the Verifier will verify. The verification criteria may be, for example, a domain name which verified users must use in email addresses, a name, address, account name, user name, password, certificate or other identifier which verified users must have or know.

At block 1230, Manage Verifier and Sponsor Routine 1200 may determine whether the party is being enrolled as a Sponsor, such as according to an element in the user interface. If affirmative at block 1230, then at block 1235, Manage Verifier and Sponsor Routine 1200 may obtain a Reward, Challenge, Event, or Place Activity which the Sponsor will sponsor and which may be available to users or to verified users. Obtaining the Reward, Challenge, Event, or Place Activity may be according to an interactive process which allows the Sponsor to define criteria for the Reward, Challenge, Event, or Place Activity.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

1. A method of awarding points for healthy lifestyle activities, performed in a computer comprising a memory, which method comprises:
in the computer memory, associating a user with a user identifier and an exercise monitor;
in the computer memory, associating the user identifier with a reward, which reward requires that the user earn points to earn the reward;
by the computer, receiving a report associated with the user identifier and calculating a number of points earned by the user based on the report; and
when the user has earned enough points to earn the reward, making the reward available to the user.

2. The method of claim 1, further comprising determining that the user may be associated with a verifier and associating the user with the verifier.

3. The method of claim 2, wherein the determination that the user may be associated with the verifier is according to a domain name in an email address used by the user.

4. The method of claim 2, wherein the reward is sponsored by the verifier.

5. The method of claim 1, wherein the report is received from at least one of the user, the exercise monitor, and a social media service.

6. The method of claim 1, wherein the report comprises at least one of a user activity report, an exercise monitor report, an event report, and a place report.

7. The method of claim 6, wherein calculating points for the user based on the report comprises adjusting a duration of or number of steps assigned to the activity, adjusting a metabolic equivalent of task value for the activity, and calculating the points based on a sigmoidal curve.

8. The method of claim 7, wherein adjusting the duration of the activity comprises adjusting the duration based on an idle time associated with the activity.

9. The method of claim 7, wherein adjusting the metabolic equivalent of task value for the activity comprises adding to the typical metabolic equivalent of task value for the activity a value which quantizes how far outside of an ordinary lifestyle the activity is and a value which quantizes an additional perceived effort required to perform the activity.

10. The method of claim 7, wherein calculating the points based on a sigmoidal curve comprises obtaining the maximum and minimum possible points, subtracting from the maximum possible points the difference between the maximum and minimum possible points for the activity multiplied by (the inverse of 0.98 plus (e raised to the power of the product of minus 4 plus ((the product of the measurement of the activity minus the minimum measurement of the activity required for any points divided by the difference between the maximum and minimum possible points) multiplied by 8.5))).

11. The method of claim 7, further comprising increasing the number of points when the activity is passively verified by the exercise monitor.

12. The method of claim 1, further comprising receiving more than one report associated with the user, determining that at least two reports of the more than one report are duplicates, and combining the at least two reports into one.

13. The method of claim 12, wherein determining that the at least two reports are duplicates comprises determining that the at least two reports share common metadata comprising at least one of a date-time, a place, and an activity type.

14. The method of claim 12, wherein combining the at least two reports into one comprises selecting either the most reliable of the at least two reports or the most optimistic of the at least two reports.

15. The method of claim 1, further comprising determining that the user has points available to be shared with at least one other user and sending a message to such other user to credit such points to such other user.

16. The method of claim 1, further comprising determining that the report satisfies the criteria of a challenge.

17. The method of claim 1, further comprising determining that the report satisfies the criteria of a badge.

18. The method of claim 1, further comprising determining that the number of points satisfies the criteria of a level.

19. A non-transient computer-readable storage medium having stored thereon instructions that, when executed by a processor, configure the processor to:
associate a user with a user identifier and an exercise monitor;
associate the user identifier with a reward, which reward requires that the user earn points to earn the reward;
receive a report associated with the user identifier and calculate a number of points earned by the user based on the report; and
when the user has earned enough points to earn the reward, make the reward available to the user.

20. A computing apparatus for assigning a location to an item, the apparatus comprising a processor and a memory storing instructions that, when executed by the processor, configure the apparatus to:
associate a user with a user identifier and an exercise monitor;
associate the user identifier with a reward, which reward requires that the user earn points to earn the reward;
receive a report associated with the user identifier and calculate a number of points earned by the user based on the report; and
when the user has earned enough points to earn the reward, make the reward available to the user.
